(19) United States
(12) Patent Application Publication
(10) Pub. No.: US 2008/0215172 A1
(43) Pub. Date: Sep. 4, 2008

(54) Non-Linear Presentation of Content

(75) Inventor: Martin Digon, Brighton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,712

(22) PCT Filed: Jul. 18, 2006
(86) PCT No.: PCT/IB2006/052452

§ 371 Date: Jan. 15, 2008

(30) Foreign Application Priority Data
Jul. 20, 2005 (EP) 05106671.0

(51) Int. Cl. G06F 17/00

(52) U.S. Cl. 700/94

(57) ABSTRACT

Media content (40) comprises content items (51), control data (55) which specifies branching points within the item at which presentation can be varied and conditional instructions to be used by the presentation device at the branching points and additional content segments (52, 53) to be used at the branching points. A media presentation device (10) presents the content item and uses the conditional instructions to vary presentation of the content item at a branching point. The media presentation device (10) maintains parameters which are used by the conditional instructions to vary presentation: a parameter of the environment external to the player; a parameter relating to operation of the player; a parameter relating to previous presentation of the content item; a parameter relating to a playlist comprising the content item; a preference of a user. Operations at a branching point include replacement, insertion, omission, repetition.

This invention relates to presentation of content obtained from a content source.

In conventional presentations of audio content, such as an audio track, the content is presented in a linear form. Data is read in a linear manner from a beginning of the audio track to the end of the audio track. This linear playback provides the same experience to the user every time the audio track is played. It is possible to control a media player so that the player varies the order in which tracks within an album or playlist are played. Typically, the player performs a random shuffle of the set of tracks in a playlist to present the set in a random manner. Although this gives some variety to the presentation, each track is played in full and variety in the playback is limited.

There have been some attempts to provide a variation to playback within a music track. US2003/0046638 A1 describes random play technology where, at various points within a work, a random selection is made between a plurality of content segments.

DE 100 53 720 A1 describes a recording method which provides three different variations for each verse, refrain and intermediate section of a sung piece of music. The variations are recorded on a single compact disc (CD) in defined areas, with the CD player allowing random selection, or a personal selection, of the different versions of each section of the recorded music. In both of the above the selection of variations is random.

The present invention seeks to provide an alternative way of presenting a content item.

Accordingly, a first aspect of the present invention provides a method of presenting media content to a user at a media presentation device, the media content comprising a content item, control data which specifies branching points within the item at which presentation can be varied and conditional instructions to be used by the presentation device at the branching points, and a plurality of additional content segments to be used at the branching points, the method comprising:

reading the control data;

presenting the content item and using the conditional instructions to vary presentation of the content item at a branching point; and,

maintaining at least one of the following parameters which is used by the conditional instructions to vary presentation:

a parameter of the environment external to the player;

a parameter relating to operation of the player;

a parameter relating to previous presentation of the content item;

a parameter relating to a playlist comprising the content item;

a preference of a user.

The conditional rules and branching points allow the ability to reproduce the content item in a non-linear manner. On successive presentations of the item different versions of the item can be experienced. Variation in presentation can be effected by replacing a content segment with an alternative segment, inserting a new segment, omitting a segment or repeating a segment. The way in which alternative playback paths are chosen depends on the conditional instructions and the parameters. The type of parameter used by the conditional instructions can allow a more varied yet intelligent control over the manner in which the content is presented to a user, which results in improved user satisfaction. Preferably multiple types of parameter are maintained by the device and used by the conditional instructions. The method can be used to provide multiple versions (remixes) of a song title and for spoken audio tracks it can provide alternative endings, languages, detail levels, background sounds. The term ‘preference of a user’ is a preference stored by a user in advance of beginning playback of the content, or as a result of using a system menu of the presentation device during presentation, and is not a result of a path selection within the content itself.

Preferably, the control data specifies the parameters that the presentation device is required to maintain for the current content item and the player uses the data to maintain only the parameters that are required. This has the advantage of saving processing and memory requirements that a presentation device needs to commit to supporting the feature, and consequently also helps to save power in a portable device.

Further aspects of the invention provide a controller for a media presentation device comprising control logic which is operable to perform this method and a media presentation device including the controller. The media presentation device can take the form of a media player (fixed or portable) which retrieves content from a storage medium local to the player, such as an optical disc player (CD, DVD, Blu-Ray™) or a player which retrieves content from a hard-disk or solid-state memory. The media presentation device can also take the form of a playback platform which receives content via a broadcast or network delivery medium, such as a set-top box, Personal Video Recorder, Personal Computer or mobile phone.

The functionality described here can be implemented in software, hardware or a combination of these. The invention can be implemented by means of hardware comprising several distinct elements, and by means of a suitably programmed processing platform. Accordingly, another aspect of the invention provides instructions (software) for causing a processor to implement the method. The instructions may be stored on an electronic memory device, hard disk, optical disk or other machine-readable storage medium. The software may be downloaded directly to a media presentation device via a network connection and can be provided as an upgrade to a device already in service.

A further aspect of the invention provides a method of authoring a media content work comprising:

providing a media content item;

generating control data which specifies branching points within the item at which presentation can be varied and conditional instructions to be used by a presentation device at the branching points;

providing a plurality of additional content segments to be used at the branching points,

wherein the conditional instructions cause presentation to be varied by the player depending on at least one of the following parameters:

a parameter of the environment external to the player;

a parameter relating to operation of the player;

a parameter relating to previous presentation of the content item;

a parameter relating to a playlist comprising the content item;

a preference of a user.

Further aspects of the invention provide a media content work resulting from the authoring method and a record carrier (e.g. optical disc, memory or signal) carrying the media content work.

Embodiments of the present invention will now be described, by way of example only, with reference to the accompanying drawings, in which:—

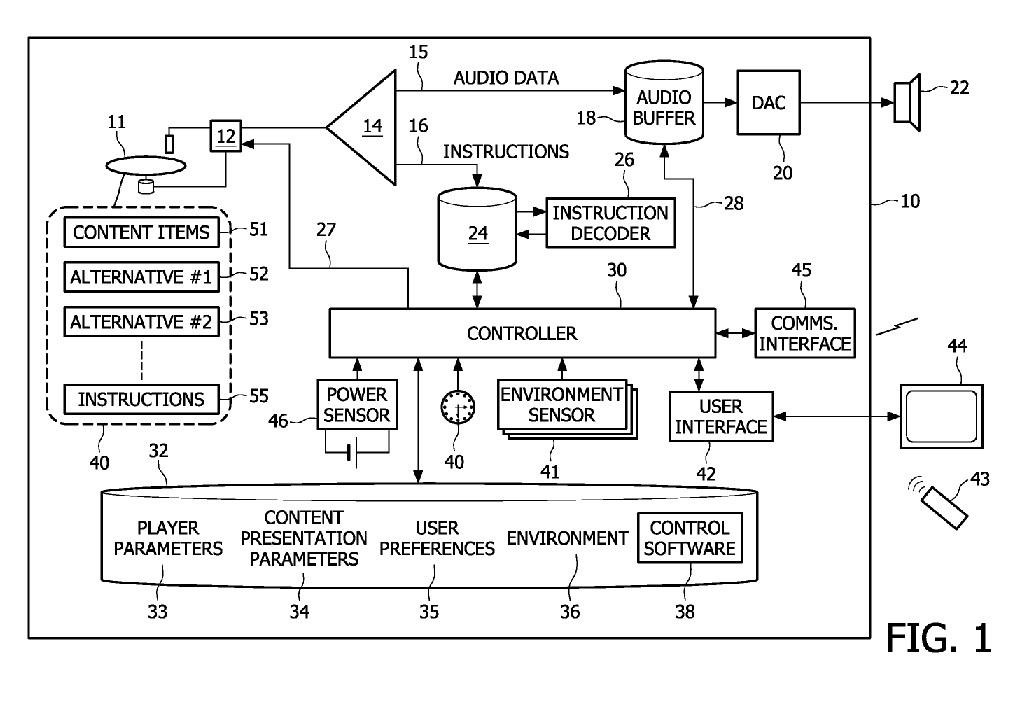

FIG. 1 shows a media player embodying the invention;

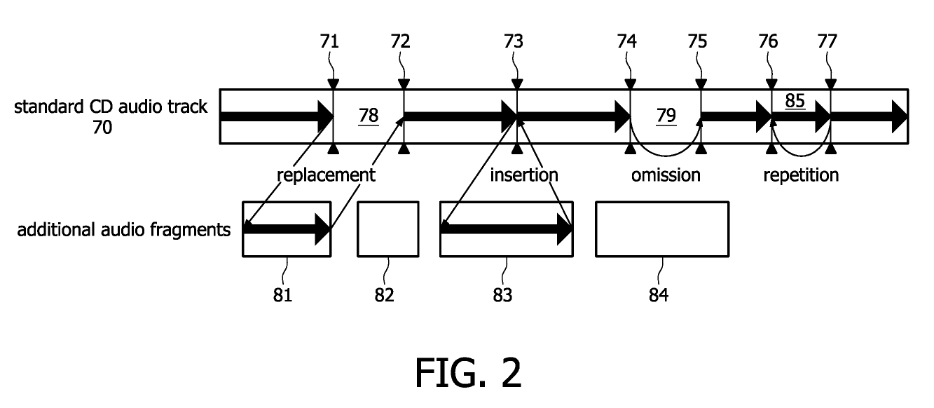

FIG. 2 shows a content item and branching points within the item and possible operations at the branching points;

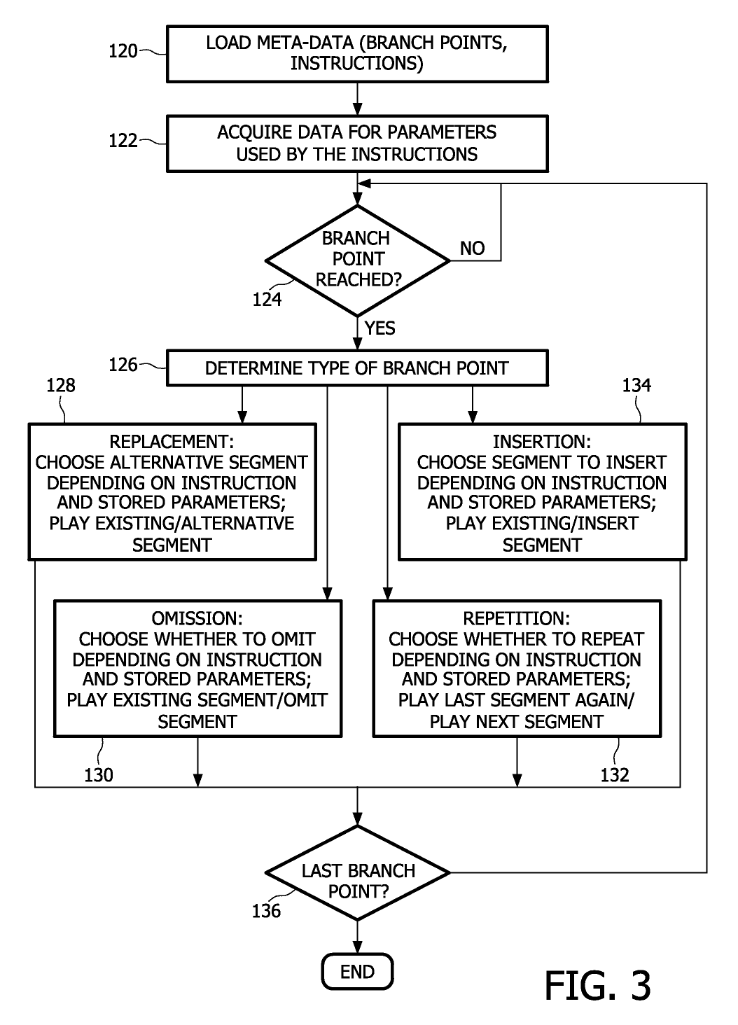

FIG. 3 shows a method of presenting content to implement the operations shown in FIG. 2;

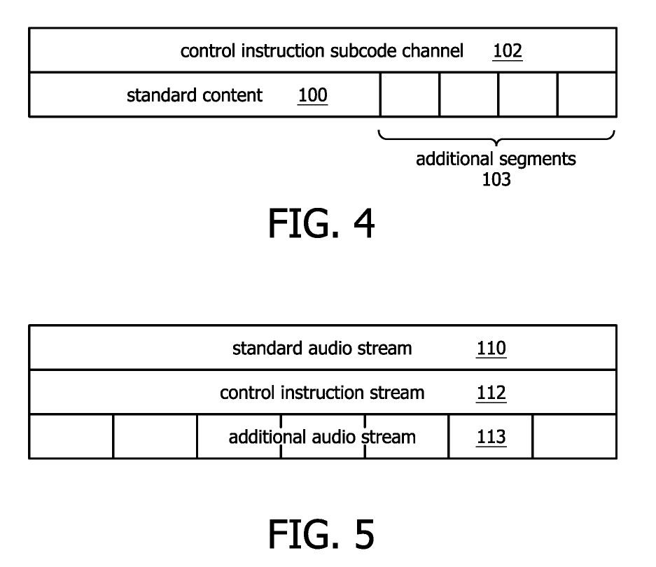

FIG. 4 shows a way of storing the alternative content segments and control data on a CD format;

FIG. 5 shows a way of storing the alternative content segments and control data in a stream-based format;

FIG. 1 schematically shows a media player 10 which embodies the present invention. In this embodiment the media player is an optical disc player, such as a player which is capable of playing discs 11 conforming to the Compact Disc (CD), Digital Versatile Disc (DVD) or Blu-Ray™ formats although the storage medium can be a solid state memory device such as a hard disk or a memory card which is fixed or removable from the player. The disc 11 carries digital data representing content items 51 in a conventional manner. Additionally, the data includes control data in the form of instructions 55 for presenting the content items. Additional content segments are also stored on the disc 11 which can be used as alternatives to segments already present in the content items 51 or as additional segments. The use of the instructions and additional segments will be described more fully below. A transport mechanism 12, which includes a drive and a read head, retrieves data from an optical disc 11 that a user wishes to view and applies retrieved data to a decoding/demultiplexing function 14. Controller 30 controls 27 the transport mechanism 12 to retrieve data from the optical disc 11. Demultiplexing function 14 applies error detection/correction to retrieved data and demultiplexes the data into audio data 15 and control data 16 which includes instructions for presenting the content. A controller 30, such as a microprocessor, executes a control application 38 which resides in a memory 32. In this embodiment the control application 38 and processor 30 form a controller for the media player although it will be readily appreciated that the controller can alternatively be implemented in hardware using an Application Specific Integrated Circuit (ASIC), a programmable array or other logic circuit. Audio data retrieved from the disc 11 is stored in an audio buffer 18 and controller 30 controls 28 the delivery of audio data from the buffer 18 to an output stage for presentation to a user. The output stage includes a digital-to-analogue converter (DAC) 20 and loudspeakers 22 or headphones. Alternatively, the output can be in the form of an analogue or digital line output signal for feeding to an audio system. Demultiplexer 14 also outputs instructions 16 for presenting the content which are stored in a buffer 24. If necessary, instructions are decoded using a decoding function 26. For ease of explanation the player shown in FIG. 1 only shows audio data 15, although it will be readily appreciated that the player could also retrieve video data and store the video data in buffer 18 in the same manner as is shown for audio data.

User interface 42 includes a set of controls which allow a user to provide control inputs to the player 10. The controls can take the form of an operating panel mounted on the media player 10 or a remote control 43. The remote control can have a graphical user interface (GUI) or the user interface can use a video overlay to display user selectable options on a display 44 connected to the player 10.

Player 10 includes one or more environment sensors which sense a quantity external to the player. The sensors can include: a temperature sensor to detect ambient temperature of the surrounding environment and a microphone to detect noise in the surrounding environment. A movement sensor, such as an accelerometer (e.g. solid state, gyroscope, mercury switch) can detect if the player is being moved/shaken. A clock 40 provides date and time data to the controller 30.

Storage 32 maintains a number of parameters which are used by the player to vary presentation of the audio data. The player may use all, or only a sub-set, of the parameters listed here. The parameters include:

(i) a parameter 36 of the environment external to the player. This can include:

time or date, derived from clock 40;

ambient temperature, derived from a temperature sensor 41 or light derived from a photo-cell;

movement of the device, derived from a movement sensor 41 within the device;

noise of the environment external to the player 10, derived from a microphone 41;

interaction with another device, derived from communications interface 43.

In the case of time/date the current time/date is stored as a parameter in a register within memory 32 or is retrieved from the clock function 40 on demand. For quantities such as temperature, light, movement and noise controller 30 receives a signal from a respective environment sensor 41 and stores an averaged value of the signal calculated over an appropriate period of time. For example, the temperature can be averaged over the last minute. Communications interface 45 is used to determine the presence of another device within range of the player 10. The communications interface 45 can be wired or wireless and can include: Wi-Fi, Bluetooth™, Ethernet, ZigBee (or other home control interfaces), SCART, S-Video, audio input (e.g. on a set-top-box), IEEE 1394, USB. Many of these interfaces provide a way of detecting the presence of other devices, and usually of identifying at least the type of device.

(ii) a parameter 33 of the player operation. This can include:

battery level, obtained from a power sensor 46 which monitors the state of a battery powering the player 10. The power sensor 46 will typically already be present within player 10 although conventionally the output of the sensor will only be used for power management of the player and to provide a ‘remaining battery level’ display on the user interface;

volume level, playback mode, time since the presentation device was turned on and time presenting the current content item.

Some of these parameters will conventionally be maintained by controller 30 for specific purposes. As an example, the current playback mode will be known by the controller and used to determine what user interface controls can be operated at that time, and how the content is presented to the user (e.g. random shuffle, programmed selection). However, this information is not conventionally used to make a modification of presentation of the content at branching points in the manner of the present invention.
(iii) a parameter 34 relating to previous presentation of the content item. This can include the number of times the current track has been presented by the device. This can be maintained on a per session basis or on an absolute basis. As used here, ‘session’ is defined as a period when a particular optical disc is loaded in the player 10, or a particular playlist and set of content items is stored in the memory of the player 10. When monitoring on a per session basis, the player records a count of the number of times each track number in the playlist is presented (in full or in part). When monitoring on an absolute basis, the player must use an identifier which uniquely identifies the track, such as a meta-data ID3 code or fingerprint obtained by performing a calculation on the contents of the content item. Whatever identifier is used, the controller maintains a count of the number of times each track is presented and stores this information in non-volatile memory 32. Each time a disc is loaded into the player, or a particular content item is stored on the player, the controller checks whether the item is already known to the player and, if it is known, the previously maintained count is incremented. In a similar manner to this, the player can maintain a parameter of the time since the item was last played. Controller 30 records the time and date of the current playback alongside a unique identifier of the track. On the next occasion that the track is played the current time/date is compared with the last played time/date for the track to determine the time since the track was last played.
(iv) a parameter relating to the playlist of which the content item is a part. There are various possibilities. The controller can examine the immediately neighbouring item in the current playlist (forward/back) and a parameter of that item, such as the genre of that item. Alternatively, a parameter of the entire playlist can be examined.
(v) user preference. Controller 30 stores a number of user preferences 35, which are set by a user using the user interface 42. These can include: genre, mood, harmony complexity, favorite instruments. These preferences can be stored in advance of a user loading a content work or can be set by interacting with a system-level menu during presentation.

FIG. 2 shows an example content item 70 which can be an audio track retrieved from disc 11. Within item 70, a plurality of branch points 71-77 are set. Control data 16 accompanying the content identifies these points 71-77. Each point within the item 70 can be referenced by an absolute time reference since the start of the item, e.g. a timecode value, as an offset from another known point (e.g. previous branch point+10 seconds) or as a percentage of track progress. Four possible operations at branching points are shown in FIG. 2. Two points 71, 72 define a segment 78 of the item 70 which can be replaced by an alternative segment. One such alternative segment 81 is shown replacing existing segment 78. Associated with branching point 71 is a conditional rule which determines whether the existing segment 78 or the alternative segment 81 is presented. The number of alternative segments is not limited to one and there can be a set of such alternative segments. The conditional rules for selecting whether an alternative segment is presented, and selecting which alternative segment is presented, are described more fully below. Branching point 73 defines an insertion point at which a supplementary segment 83 can be inserted. Associated with branching point 73 is a conditional rule which determines whether the supplementary segment 83 is inserted. Branching points 74, 75 define a segment 79 of the item 70 which can be omitted. Associated with branching point 73 is a conditional rule which determines whether segment 79 is omitted. The omission can be implemented as a jump forward to a particular time within the track (specified by branching point 75) or as a jump forward by a particular time offset. Branching points 76, 77 define a segment 85 of the item 70 which can be repeated. Associated with branching points 76, 77 is a conditional rule which determines whether segment 85 is repeated or the next segment is presented. Conditional rule can also specify how many times the segment is repeated and conditions for subsequent repeats. The set of alternative/additional content segments 81-84 are stored alongside content item 70 and are retrieved from disc 11 into audio buffer 18. There are various ways in which the alternative segments can be stored and managed. Alternative segments can be stored on the disc at specified locations and retrieved, on demand, from those locations. Alternatively, a number of alternative segments can be retrieved in advance and cached in buffer 18. The control data (instructions) can follow the conventional [instruction type][instruction parameters] structure used by most computer processors, for example. A sequence of decision point instructions can take the form:

[branching_point_{—}1 instructions];

[branching_point_{—}2_instructions]; . . .

[branching_point_n_instructions]

where each [branching_point_n_instructions] contains:

[branching_point][target_{—}1_details][target_{—}2_details] . . .

[target_n_details]

where [branching_point] is the time location of the branching point (e.g. 0:02:54.510 in hours:minutes:seconds.milliseconds format), and for each possible branch destination, [target_n_details] contains:

[target_point][decision_parameter_{—}1][decision_parameter_{—}2] . . .

[decision_parameter_n]

where [target_point] is the time location of the point to jump to, depending on a weighted sum of the results of the decision parameters, and for each decision parameter, [decision_parameter_n] contains:

[input_type][input_value][weighting]

where [input_type] is the input to consider (any of 33-36 in FIG. 1), [input_value] is the value of the input that is relevant, and [weighting] provides a way of indicating the importance of this decision parameter compared to the others.

The way in which alternative playback paths are chosen is determined by the conditional rules stored as meta-data accompanying the content. The rules, in turn, use one or more of the parameters described above and maintained by the controller 30. Additionally, the selection of segments at some branching points can be entirely random.

FIG. 3 shows the control logic for controlling operation of this function on a media player. At step 120 the player loads meta-data which specifies the branching points and conditional instructions which determine whether an alternative path is followed and the logic for choosing an alternative path. At step 122 the player acquires data for the parameters that will be used by the conditional instructions. The parameters have been described above. At stage 120 some of the meta-data loaded may specify the types of parameters that the player is required to maintain for the next content item or set of content items in the playlist. This can allow the player to save processing resources by only maintaining the parameters that will be required. The parameters are maintained (i.e. regularly updated) during presentation of content. At step 124 a check is made whether a branch point has been reached in playback of the current item. If a branch point has been reached the logic determines the type of branch point at step 126. The four types of behaviour at a branch point are described at steps 128, 130, 132, 134. In each case, conditional instructions associated with the branch point (or pair of branch points in the case of replacement, omission and repetition) determine whether the content item is played as normal or whether playback is modified. When the behaviour at a branch point has been completed, the control logic determines whether there are any further branch points associated with the content item at step 136. If there are, the control logic returns to step 124. Otherwise, the control logic causes the method to end.

FIGS. 4 and 5 show two possible ways of storing the content, additional content segments and instructions. Firstly, FIG. 4 shows a CD-based format where backwards-compatibility is required. A full track of audio data 100 is included in the standard way. The CD standards allow subcode channels which are primarily intended for CD-graphics and CD-text. A subcode channel 102 is used to store the control instructions, including the branching points and conditional instructions. Space at the end of the disc is used to store any additional audio fragments 103 that may be inserted into the main audio track or used to replace parts of the main audio track.

FIG. 5 shows a stream-based format such as MP3. A full stream of audio data 110 is included in the standard way. A control data stream 112 carries control instructions, including the branching points and conditional instructions. Additional audio streams 113 are added to carry additional audio fragments. The creation of additional streams is permitted by the MPEG specifications.

The arrangement described above permits a wide range of presentation possibilities for a content item. Some examples of conditional rules, and use of the rules to vary presentation, will now be described.
A conditional rule varies playback of a particular segment depending on the number of times a track has previously been played. Alternative versions of the segment present a more somber version of the segment. As the track is repeatedly played, that segment becomes increasingly more somber. Alternative versions of the segment may vary in some other characteristic and may even contain hidden content (a so-called ‘Easter Egg’) when the item has been played a sufficient number of times.
A conditional rule varies playback of a particular segment depending on how recently the track was last played. A longer version of a track is played if the user has not listened to it for more than a predetermined time, e.g. a week. The increased length of the track can be achieved by specifying branching points at the chorus and providing a rule which repeats segments of the track (e.g. the chorus) or by specifying branching points which allow the insertion of additional segments.
A set of alternative segments of a track are stored. A conditional rule specifies that the player should play a different alternative segment every time the track is played. The rule causes the player to store a parameter which identifies the track and the version that is played and causes the player to update the list of played versions each time the track is played.
A conditional rule selects a segment depending on the playback mode that the user has selected. If the playback mode is “shuffle” then a segment is selected with increased instrumental improvisation.
A conditional rule selects a segment depending on the current volume setting on the player. As an example, the player selects a version of a track with more drums if the track is being played back at loud volume.
A conditional rule selects a version of a track with emphasis on the bassline if the user has set the player's equalizer to enhance low frequencies, or selects a version of the track that matches an equalizer preset on the player (e.g. “jazz”).
A conditional rule selects a version of the track that matches the genre information stored on the next and previous tracks in a playlist, making the overall genre of the playback more consistent.
A conditional rule selects a segment depending on the time of day: lively in the mornings, relaxing in the evenings.
A conditional rule selects a segment depending on the date: e.g. the track character or duration is different on Fridays, or in the summer, or a predetermined period after release. This can reveal hidden alternative lyrics or musical segments when played on a date such an anniversary or birthday of the user or artist, season or any other significant date.
A conditional rule presents a track whose length depends on the time since the player was switched on.
A conditional rule selects segments which vary in character according to battery level, e.g. gloomier track versions are selected as the battery level decreases.
A conditional rule selects segments depending on conditions in the environment surrounding the player, e.g. segments with tropical rhythms are selected in hot weather; mellow segments are selected in low lighting conditions; livelier track versions are selected when the motion detector senses movement of the player, perhaps because the owner is jogging or working out; language learning tracks with less background sound effects are selected when there is a high level of ambient noise.
A conditional rule selects segments of a track if there is a certain number and type of Wi-Fi devices within range of the player.
A conditional rule selects segments of a track to vary the genre: e.g. salsa instead of reggae rhythms, different chorus/verse structures, tempo changes; character: e.g. darker basslines, happier vocals, heavier drums, more improvisation on the instrument parts; voices and sound effects: e.g. different ambient noises, background music and accent/intonation combinations for spoken word audio (language learning, theatrical plays).
   The effects and inputs can be combined by content creators to provide even richer and more interactive behaviours, such as:
language learning audio that presents audio to the user with the same text spoken in increasingly difficult regional accents depending on how many times, how often and how recently the user has listened to the audio;
a language-learning ‘listening comprehension’ audio tool that begins with some basic speech in a neutral accent, and every time the tool is accessed by a user uses a combination of stronger regional accents, more complex grammar, more new words, or louder and more distracting background noise (e.g. background noise simulating a ‘real’ environment such as an office or pub);
music that contains many different bonus lyrics and choruses that can only be accessed by listening to it on a particular date in a location that contains a particular wi-fi device;
music that can match the lighting and noise conditions, mood and favorite instruments of the user;
music that loops continuously until the user produces a large noise or shakes the player;
a song that sounds livelier if it's a cold Monday, and includes three hidden choruses: one that only appears on the composer's birthday, one that only appears if the player is within radio range of another player, and one that only appears a year after the song was originally released;
a song that matches the mood of the songs that play before and after itself, and includes a solo by the user's favorite instrument;
alternative endings for a children's (audio) book, where the story has different endings depending on the time of year;
an audio book or radio-style play where certain characters speak in different languages depending on the location of the player (e.g. Dutch if played in the Netherlands or German in Germany).

User preferences can be used by the conditional instructions to select segments, or to bias decisions, to match the preferences of the user.

For clarity, the embodiment above describes presentation of an audio content item. However, the invention is not limited to audio and can be applied to other types of content such as video or multimedia content.

Alternatively, the content can be stored on a storage device such as a hard disk or memory card which is fixed or removable from the device, or can be received from a broadcast channel or a network server via a network communications interface. For a broadcast-receiving device, transport mechanism 12 is replaced by a broadcast tuner and front-end which can retrieve content from a selected broadcast channel. For a networked device, transport mechanism 12 is replaced by a network interface, such as a Digital Subscriber Line (DSL) interface, to connect to a network (e.g. Internet) server and retrieve content from the server.

The embodiment described above can be realised as a dedicated media player (e.g. a standalone CD/DVD player or a portable media player) or a software player on a multi-purpose computing platform such as a personal computer (PC), handheld computer or mobile phone.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim. Where the system/device/apparatus claims recite several means, several of these means can be embodied by one and the same item of hardware.

In the description above, and with reference to the Figures, there is described media content 40 which comprises content items 51, control data 55 which specifies branching points within the item at which presentation can be varied and conditional instructions to be used by the presentation device at the branching points and additional content segments 52, 53 to be used at the branching points. A media presentation device 10 presents the content item and uses the conditional instructions to vary presentation of the content item at a branching point. The media presentation device 10 maintains parameters which are used by the conditional instructions to vary presentation: a parameter of the environment external to the player; a parameter relating to operation of the player; a parameter relating to previous presentation of the content item; a parameter relating to a playlist comprising the content item; a preference of a user. Operations at a branching point include replacement, insertion, omission, repetition.

1. A method of presenting media content to a user at a media presentation device, the media content comprising a content item (51), control data (55) which specifies branching points (71-77) within the item at which presentation can be varied and conditional instructions to be used by the presentation device at the branching points, and a plurality of additional content segments (52, 53) to be used at the branching points, the method comprising:
reading the control data (55);
presenting the content item and using the conditional instructions to vary presentation of the content item at a branching point; and,
maintaining at least one of the following parameters which is used by the conditional instructions to vary presentation:
a parameter of the environment external to the player (36);
a parameter relating to operation of the player (33);
a parameter relating to previous presentation of the content item (34);
a parameter relating to a playlist comprising the content item;
a preference of a user (35).

2. A method according to claim 1 wherein the branching points (71-77) define at least one of: a segment of the item which can be replaced; a point at which a new segment can be inserted;
a segment of the item which can be omitted and a segment of the item which can be repeated.

3. A method according to claim 1 wherein the parameter of the environment external to the player (36) is at least one of: time; date; temperature; light; movement; noise; and interaction with another device.

4. A method according to claim 1 wherein the parameter of the player (33) is at least one of: battery level; volume level; playback mode; time since the presentation device was turned on; and time presenting the current content item.

5. A method according to claim 1 wherein the parameter relating to previous presentation of the content item (34) is a number of times the content item has been presented by the device.

6. A method according to claim 5 further comprising storing an identifier of the content item and a count of the number of times the item has been presented and updating the count each time the content item is presented.

7. A method according to claim 1 wherein the parameter relating to a playlist is at least one of: the genre of a content item before or after the current content item; and the genre of the playlist.

8. A method according to claim 1 wherein the user preference is at least one of: genre, mood, harmony complexity, favorite instruments.

9. A method according to claim 1 wherein the control data specifies the parameters that the presentation device is required to maintain for the current content item and the player uses the data to maintain only the parameters that are required.

10. A controller for a media presentation device (10) comprising control logic which is operable to perform the method according to claim 1.

11. A media presentation device (10) comprising a content retrieval function for retrieving media content from a content source, a media presentation function for presenting retrieved content and a controller according to claim 10.

12. A media presentation device according to claim 11 further comprising a transport mechanism (12) for retrieving media content from a removable storage medium (11).

13. A media presentation device according to claim 11 further comprising a network interface for retrieving media content from a networked or broadcast content source.

14. Instructions for causing a processor to perform the method of claim 1.

15. A machine-readable carrier storing the instructions of claim 14.

16. A method of authoring a media content work comprising:
providing a media content item;
generating control data which specifies branching points within the item at which presentation can be varied and conditional instructions to be used by a presentation device at the branching points;
providing a plurality of additional content segments to be used at the branching points, wherein the conditional instructions cause presentation to be varied by the player depending on at least one of the following parameters:
a parameter of the environment external to the player;
a parameter relating to operation of the player;
a parameter relating to previous presentation of the content item;
a parameter relating to a playlist comprising the content item;
a preference of a user.

17. A method according to claim 16 wherein the conditional instructions cause presentation to be varied by the player depending on a plurality of the parameters.

18. A media content work resulting from the authoring method of claim 16.

19. A record carrier carrying the media content work of claim 18.
